(19) United States
(12) Patent Application Publication
(10) Pub. No.: US 2025/0113763 A1
(43) Pub. Date: Apr. 10, 2025

(54) Water-Soluble Seed and Fertilizer Packet

(71) Applicant: John DiPaolo, JR., NEW BEDFORD, MA (US)

(72) Inventor: John DiPaolo, JR., NEW BEDFORD, MA (US)

(21) Appl. No.: 18/480,887

(22) Filed: Oct. 4, 2023

(51) Int. Cl. A01C 1/04

(52) U.S. Cl. CPC A01C 1/04

(57) ABSTRACT

A novel seed and fertilizer packet is provided. The packet is designed to simplify gardening processes while reducing environmental waste. The packet material is formed of a water-soluble material such as a water-soluble paper. The packet may be formed as a single unit with two distinct pouches separated by an adhesive layer, effectively isolating fine grains of fertilizer and seeds. The first pouch contains water-soluble or suspending fertilizer selected to support seed growth. The second pouch houses seeds ready for planting.

### BACKGROUND OF THE INVENTION

The present disclosure relates generally to seed packets. More particularly the present disclosure relates to a seed packet formed of a water-soluble material which also contains a quantity of fertilizer in a pouch that is separate from a pouch containing the seeds.

Traditional gardening practices have long relied on the use of conventional seed packets to distribute seeds for planting. Such seed packets are simply made of a paper or plastic envelope containing the seeds. While these packets have served their purpose for many years, they are not without their challenges and limitations. As gardening continues to evolve and adapt to modern needs, it becomes apparent that these traditional seed packets present several issues that can hinder the gardening experience. Traditional seed packets cause a number of challenges including, but not limited to the following.

Mess and Disorganization: Traditional seed packets often consist of flimsy paper or plastic envelopes that can easily tear or degrade. Handling these packets, especially in outdoor settings, can result in spilled seeds, making it challenging to keep the planting area neat and organized. This mess can lead to difficulties in seed identification and proper spacing during planting.

Cumbersome Transportation: Gardening frequently involves moving from one area of the garden to another, and traditional seed packets can be cumbersome to carry around. They are often loose and can be easily blown away by the wind, misplaced, or covered in soil during the gardening process. This makes them difficult to manage and can slow down the planting process.

Environmental Impact: Many traditional seed packets are made from non-biodegradable materials like plastic or laminated paper. These materials contribute to plastic waste and do not align with sustainable gardening practices. Even typical papers, while eventually biodegradable, take quite a long time to break down and are unsightly if strewn around a garden. Gardeners are increasingly seeking environmentally friendly alternatives to reduce their ecological footprint.

Waste Generation: After planting, traditional seed packets typically serve no further purpose and are disposed of as waste. As is well known, traditional paper and paper-based products are not water soluble because, among other reasons, the cellulose used in traditional paper is not water-soluble. Thus the paper must be disposed of through typical trash disposal programs. This disposal can be problematic, especially when the materials used are not biodegradable. Gardeners often seek ways to minimize waste and adopt greener gardening practices.

Limited Integration with Fertilizer: In conventional gardening, the distribution of seeds and fertilizer can be disjointed. Gardeners typically need to separately prepare the soil and add fertilizer, which can be time-consuming and inefficient. There is a desire for integrated solutions that streamline the planting and fertilization processes.

Loss of Nutrient Value: Traditional seed packets do not typically incorporate fertilizers into their design. This means that seeds may be planted without immediate access to essential nutrients, potentially delaying or inhibiting germination and healthy plant growth. Gardeners look for ways to ensure optimal nutrient availability for their plants.

Lack of Convenience: Traditional seed packets may require the gardener to juggle multiple items, such as seed packets, fertilizer containers, and watering cans. This can be inconvenient, particularly for novice gardeners or those with limited gardening space. A desire exists for more user-friendly and convenient gardening solutions.

Recognizing these challenges, there is a growing need for innovative approaches to seed and fertilizer distribution in gardening. Gardeners are seeking alternatives that simplify planting, reduce waste, and provide a more environmentally conscious way to cultivate plants and produce.

### SUMMARY OF THE INVENTION

The subject matter of this application may involve, in some cases, interrelated products, alternative solutions to a particular problem, and/or a plurality of different uses of a single system or article.

In one aspect, a water-soluble seed and fertilizer packet is provided. The water-soluble packet defines two pouches. A first of the two pouches contains a quantity of seeds. A second of the two pouches contains a quantity of water-soluble fertilizer. The packet material itself is formed of a water-soluble material such as water-soluble paper. A quantity of adhesive joins opposing interior sides of the packet together to form the two separated pouches. In a particular embodiment, the adhesive extends from sidewall (or side-edge) to sidewall to ensure separation of the contents in each pouch of the packet.

In another aspect, a method of gardening is provided. The method involves the step of obtaining a water-soluble seed and fertilizer packet comprising a quantity of seeds in a first pouch of the packet and a quantity of fertilizer in a second pouch. A user may then open the first pouch and remove the quantity of seeds. Next, the packet may be placed into a quantity of water along with the fertilizer. As both are water soluble, the packet and fertilizer dissolve into the water, eliminating any waste and simultaneously providing an enriched fertilizer-water for watering the seeds. The seeds may then be watered with the fertilizer-water to encourage seed growth.

In yet another aspect, a water-soluble seed and fertilizer packet assembly is provided. A water-soluble seed and fertilizer packet is contained within a protective sleeve. The water-soluble packet defines two pouches. A first of the two pouches contains a quantity of seeds. A second of the two pouches contains a quantity of water-soluble fertilizer. The packet material itself is formed of a water-soluble material such as water-soluble paper. A quantity of adhesive joins opposing interior sides of the packet together to form the two separated pouches. In a particular embodiment, the adhesive extends from sidewall to sidewall to ensure separation of the contents in each pouch of the packet.

### BRIEF DESCRIPTION OF DRAWINGS

FIG. 1 provides an elevation of an embodiment of the present disclosure.

FIG. 2 provides a view of use of an embodiment of the present disclosure.

FIG. 3 provides an elevation view of an embodiment of a blank for forming the packet of the present disclosure.

FIG. 4 provides a side view of an embodiment of an embodiment of the present disclosure.

FIG. 5 provides a flow chart of an embodiment of use of the present disclosure.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a seed packet. This seed packet is formed of a water-soluble material such as water-soluble paper and contains both seeds for planting and fertilizer, in a separate pouch from the seeds, for providing nutrients to the seeds to encourage growth.

In most embodiments, the entire packet, including the water-soluble paper material, adhesive, and fertilizer, is constructed from water-soluble materials, such as processed cellulose-based paper or equivalents. This allows for safe disposal of the entire packet in a water source, eliminating waste. Water-soluble paper is a type of paper that is designed to dissolve in water when it comes into contact with it. This unique paper is made using specialized materials and manufacturing processes that allow it to break down and disintegrate in water, leaving no residue behind. Water-soluble paper is typically composed of natural fibers, such as wood pulp or cotton, and a water-soluble polymer, such as polyvinyl alcohol (PVA). The paper's main structure is made of conventional paper materials, while the water-soluble polymer is integrated into the matrix. Of course, other water-soluble materials, such as a water-soluble plastic film, may also be used without straying from the scope of this invention.

In practical use, the gardener can open the seed pouch, plant the seeds, and dissolve the remaining packet in a watering can filled with water. This nutrient-rich fertilizer-water solution can then be used to nourish the planted seeds. The absence of waste material simplifies gardening, enhancing convenience and environmental friendliness. Additionally, a blank for forming the seed packet is provided, allowing for the creation of a single-piece water-soluble packet using tabs with water-soluble adhesive. Perforations in the sheet ease access to the seed pouch, and the tabs effectively seal the packet.

In summary, the water-soluble seed and fertilizer packet presents a sustainable and practical solution to streamline gardening, reduce waste, and promote environmentally friendly horticultural practices.

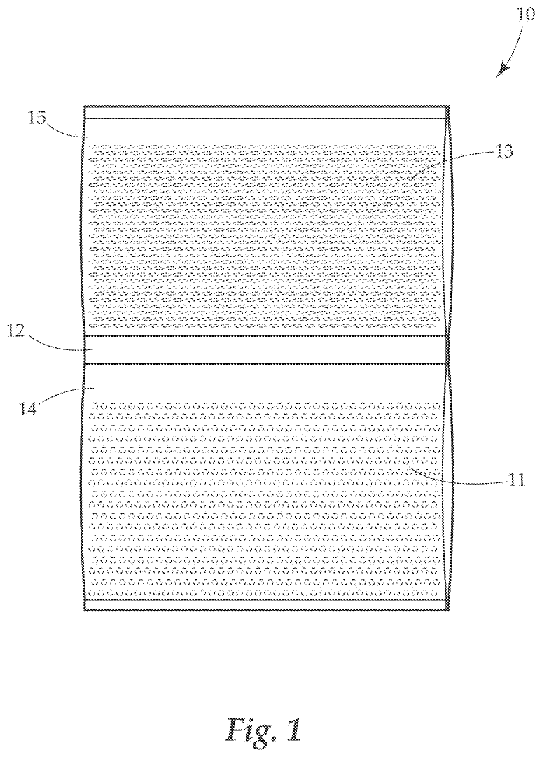

Turning now to FIG. 1, an embodiment of the seed and fertilizer packet of the present disclosure. The packet 10 is formed as a single unit having two separate pouches 14, 15 which are separated by a layer of an adhesive material 12 which joins opposing sides of the packet material together and acts as a divider to form the two pouches 14, 15. The adhesive 12 extends from sidewall to sidewall of the packet 10 so as to seal the pouches 14, 15 from each other, preventing transfer of the fine grains of fertilizer 11 and the potentially fine seeds 13. Fertilizer 11 is located in the first pouch 14, and seeds 13 are located in the second pouch 15. Typically, the fertilizer is selected to provide nutrients selected to be useful to support growth of the seeds in the packet. Preferably the fertilizer 11 is water soluble or able to form a suspension in the water. The second pouch 15 containing seeds 13 can be opened and planted or prepared for planting. The fertilizer can be mixed into water for later fertilizing the planted seeds.

Importantly, the packet 10 is formed entirely of a water-soluble paper material such as processed cellulose-based paper and equivalents. This allows the packet 10 to be completely and safely disposed of in a source of water such as a watering can, hole in the dirt which is filled with water, laid on the ground and sprayed with a hose, and the like. In certain packaging embodiments, one or more packets 10 may be contained in a protective sleeve such as a traditional paper sleeve, plastic sleeve, and the like. The sleeve may protect the water-soluble paper from being exposed to water when not intended. In operation, seed packets 10 may be removed from the sleeve before going to an outdoor location to plant, so that there is not added waste material to carry around when gardening. Also importantly, any other material used on the packet 10, including adhesive 12 is also water-soluble. This allows for the entire packet 10, including fertilizer 11 and adhesive 12, to dissolve in water once the seeds 13 are removed.

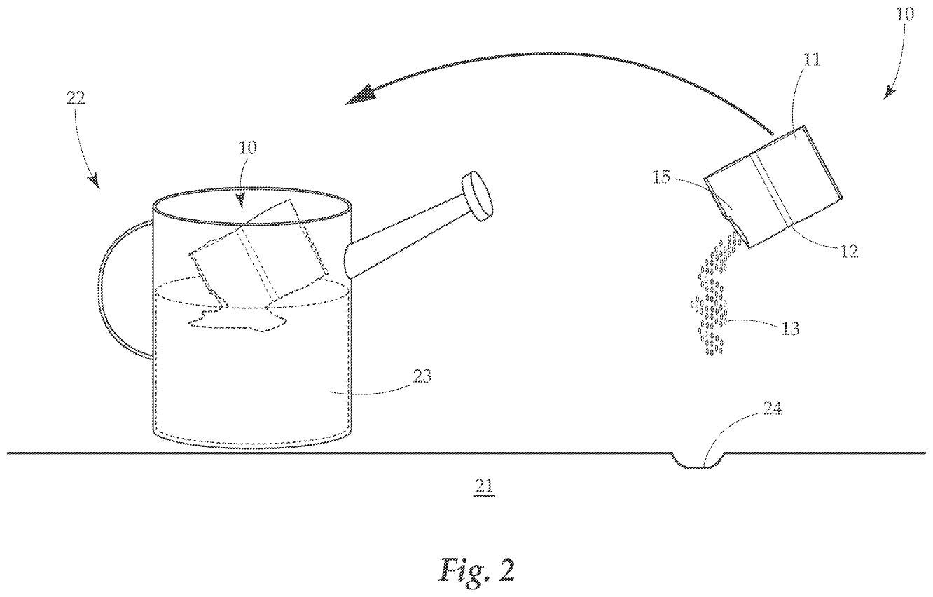

FIG. 2 shows an embodiment of use of the seed and fertilizer packet 10. The packet 10 may have the seed pouch 15 opened and the seeds 13 removed. At this point, the remainder of the packet 10 (water-soluble packet material, adhesive 12 and fertilizer 11) can be dissolved in water. In this embodiment, the remainder of the packet 10 is dissolved in a watering can 22 filled with water 23. The packet 10 may be left unattended in the water while a gardener proceeds to plant the seeds 13. In this embodiment, the seeds 13 are placed in a hole 24 or holes in the ground 21, and then covered with soil. The watering can 22, now having the fertilizer 11 and packet material dissolved therein, can be used to water the planted seeds with nutrient rich fertilizer. Once finished, the gardener has zero waste to carry, just any tools and the watering can. This provides a very easy, mess free, convenient and environmentally friendly gardening system. The present system further solves the problems in the art of having many messy and cumbersome seed packets to carry around while gardening, which can be blown away, misplaced, covered in soil, and the like making them difficult to manage.

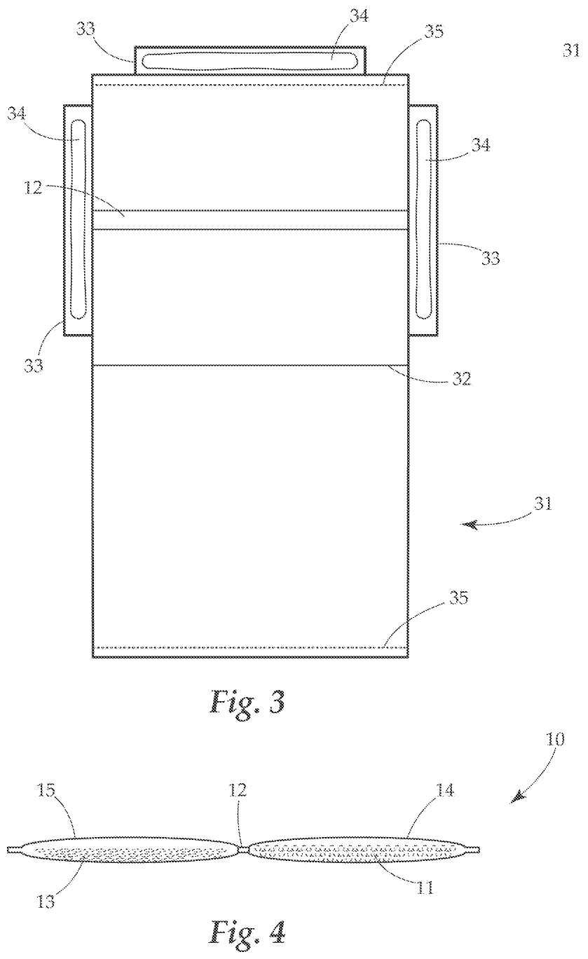

FIG. 3 provides a view of a blank for forming into the seed packet. The blank allows the seed packet 10 to be formed of a single piece of water-soluble paper. The sheet 31 can be folded upward at fold 32, which may be an inset or score, or may simply be the area at which the sheet 31 is folded. The bottom of the sheet 31 is aligned with the top and then adhesive 12 may be used to join the bottom and top of the sheet 31 together. In this embodiment, adhesive 12 may be a contact adhesive that is pre-placed on the sheet 31. In a further embodiment, a strip of contact paper may be placed on the adhesive 12. When folded in place, the contact paper may be removed and the sheet 31 bottom end can be urged against the adhesive 12 to connect the sheet. Tabs 33 are on a top and sides of the sheet 31. These tabs 33 may be folded over to fully seal the packet. In this embodiment, tabs 33 have an adhesive 34 disposed thereon. The adhesive 34, like adhesive 12 is a water-soluble adhesive for dissolving purposes, and preferably a pressure sensitive contact adhesive, allowing the tabs to be folded over and urged against the sheet 31 to hold it in place. In a further embodiment, a strip of contact paper may be placed on the adhesive 34. When folded in place, the contact paper may be removed and the tabs 33 can be urged against the adhesive 34 to connect to the sheet 31. In this embodiment, the sheet 31 has perforations 35 at top and bottom. When folded into the packet 10, the perforations align with the seed pouch 15 for easy tearing. Importantly, the perforations 35 are spaced far enough from an edge of the sheet 31 so that the folded over tap 33 does not pass over the perforations, rendering them ineffective.

FIG. 4 shows a side cutaway view of an embodiment of the packet. The packet 10 is formed into two separate pouches by the end walls, side walls, and adhesive 12 which extends from side wall to side wall to seal the seed pouch 15 and fertilizer pouch 14. Seeds 13 are in the seed pouch 15 and fertilizer 11 such as granular or solid fertilizer 11 is in the fertilizer pouch 14. As noted above, packet is formed of a water-soluble and quickly dissolvable paper material or other equivalent water-soluble material so that the entire packet 10 can be dissolved in water that is on hand in the gardening process, eliminating waste and the need to manage the waste. While disclosed herein as an adhesive layer, it should be understood that in other embodiments, other structures may be used to hold the edges of the packet together to define the two pouches, including, but not limited to mechanical connections, crimping, folding, a single strip of material, and the like.

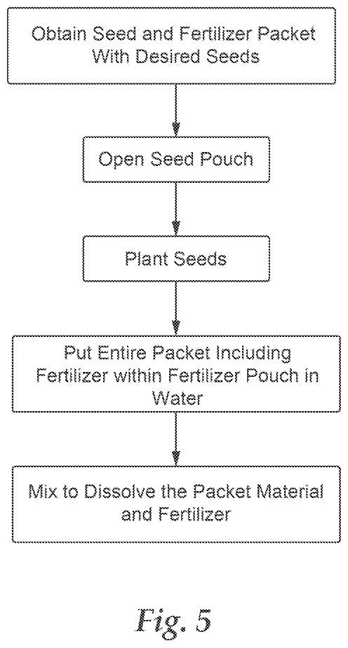

FIG. 5 provides a flow chart of one embodiment of use of the seed and fertilizer package of the present disclosure. In this process, a gardener obtains a seed and fertilizer packet with the desired seeds to be planted. The gardener may then open the seed pouch portion of the packet and empty the seeds from the seed pouch. The seeds may then be planted or placed aside to be planted. The entire remainder of the packet, which comprises fertilizer (preferably water-soluble granular fertilizer), water-soluble paper, and adhesive to hold the packet together, into a watering can or similar water vessel. The vessel with water and packet may be mixed or agitated to quickly dissolve the packet, or may be left to sit and slowly dissolve. The seeds, if placed aside, can be planted while the user is waiting for the packet and contents to dissolve. In another similar embodiment, the packet may be dissolved into the ground either before or after seed planting in the area of seed planting by spraying water on top of it while on the ground. This may be convenient in instances without a watering can, though may result in a more concentrated area of fertilizer disposition rather than spreading it out evenly.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A water-soluble seed and fertilizer packet comprising:
a water-soluble packet defining two pouches, a first of the two pouches containing a quantity of seeds, a second of the two pouches containing a quantity of water-soluble fertilizer;
wherein the packet is formed of a water-soluble material and comprises a quantity of adhesive joining opposing walls of the packet together to create the two pouches on either side of the water-soluble adhesive.

2. The water-soluble seed and fertilizer packet of claim 1 wherein the first of the two pouches comprises a perforation across at least a portion of a width of the packet.

3. The water-soluble seed and fertilizer packet of claim 1 further comprising a plurality of tabs forming a seal around edges of the packet.

4. The water-soluble seed and fertilizer packet of claim 3 wherein the first of the two pouches comprises a perforation across at least a portion of a width of the packet, the perforation spaced away from one of the plurality of tabs.

5. The water-soluble seed and fertilizer packet of claim 1 wherein the adhesive is a water-based adhesive.

6. The water-soluble seed and fertilizer packet of claim 1 wherein the packet is formed of a single piece of water-soluble paper.

7. The water-soluble seed and fertilizer packet of claim 1 wherein the packet is formed of a water-soluble paper.

8. The water-soluble seed and fertilizer packet of claim 1 wherein the fertilizer provides nutrients specific to the quantity of seeds.

9. A method of gardening comprising:
obtaining a water-soluble seed and fertilizer packet comprising a quantity of seeds in a first sealed pouch of the packet and a quantity of fertilizer in a second sealed pouch;
opening the first pouch;
removing the quantity of seeds from the first pouch;
placing the packet into a quantity of water;
allowing the packet and fertilizer to dissolve in the quantity of water; and
watering the quantity of seeds with the quantity of water having the fertilizer and packet dissolved therein.

10. The method of claim 9 wherein the step of placing the packet comprises placing the packet with the fertilizer sealed within the second pouch.

11. The method of claim 9 wherein the step of placing the packet comprises opening the second pouch and pouring the fertilizer into the quantity of water, and placing the packet into the quantity of water.

12. The method of claim 9 further comprising the step of planting the seeds.

13. The method of claim 12 wherein the step of planting the seeds is performed at the same time as the step of allowing the packet and fertilizer to dissolve.

14. The method of claim 12 wherein the step of watering the quantity of seeds is performed after the step of planting the seeds.

15. The method of claim 9 wherein the first of the two pouches comprises a perforation across at least a portion of a width of the packet, and wherein the step of removing the quantity of seeds comprising tearing the packet along the perforation.

16. The method of claim 9 wherein the packet is formed of water-soluble paper.

17. The method of claim 16 wherein the packet comprises a quantity of water-soluble adhesive extending from side edge to opposing side edge to define the first pouch and second pouch.

18. The method of claim 12 wherein the step of planting the seeds comprises digging one or more holes, placing seeds in the one or more holes, and covering the soil, and wherein the step of watering comprises pouring the quantity of water over the soil-covered seeds.

19. The method of claim 9 wherein the packet is formed of a single piece of water-soluble paper.

20. A water-soluble seed and fertilizer packet assembly comprising:
a water-soluble packet defining two pouches, a first of the two pouches containing a quantity of seeds, a second of the two pouches containing a quantity of water-soluble fertilizer;
wherein the packet is formed of a water-soluble material and comprises a quantity of adhesive joining opposing walls of the packet together to create the two pouches on either side of the water-soluble adhesive; and
a non-water soluble sleeve containing the water soluble packet.
